(19) United States
(12) Patent Application Publication
(10) Pub. No.: US 2004/0222160 A1
(43) Pub. Date: Nov. 11, 2004

(54) Method and device for the removal of contaminant layers from water surfaces

(76) Inventor: Erich Kumpf, Cala Millor (ES)

Correspondence Address: Felix J D'Ambrosio, Jones Tullar & Cooper, PO Box 2266 Eads Station, Arlington, VA, 22202, US

(21) Appl. No.: 10/296,948

(22) PCT Filed: May 10, 2001
(86) PCT No.: PCT/EP01/05368

(30) Foreign Application Priority Data
May 11, 2000 (DE) 100230326
Nov. 23, 2000 (DE) 100582702

(51) Int. Cl. C02F 1/40; E02B 15/00

(52) U.S. Cl. 210/691; 210/242.4; 210/924

(57) ABSTRACT

The invention relates to a method for the removal of contaminant layers from water surfaces by means of planar bodies, made from open-celled foam plastic, whereby the planar body is laid on the surface of the water and, after saturation thereof with the oil, is drawn in. In order to guarantee that, during such a process all planar bodies made from open-celled foam plastic directly reach the site of application, in other words the contaminated water surface, said planar body is paid out under water.

The present invention relates to a method and equipment for removal of contamination layers from water surfaces, according to the preamble of claim 1, or, respectively, that of claim 18 or 19, and to a container for use in a method and/or equipment.

In the soiling of waters through oil pollution or oil catastrophes, which can occur in major amounts in the case of oil tanker accidents and in smaller amounts also through illegal discharge of oil residues from the engine area of ships, the oil spreads horizontally outwards on the water. The thinnest, silvery-shimmering oil films have a layer thickness around 0.1 μm; thicker, colored-shimmering oil films have a layer thickness of 1 μm or above. Thicker, darker oil carpets have layer thicknesses that can lie in the centimeter range and, in the case of viscous oils, are composed of water-oil emulsions. Analogous considerations hold for other contamination substances, such as liquid plastics, for instance styrene.

In one approach to fighting oil accidents, chemicals are applied, particularly dispersants, which do remove the oil from the surface of the water and disperse it into the water mass, but, especially in ecologically sensitive areas, such as mud flats, this can lead to still greater ecological damage.

Consequently, mechanical methods of fighting oil accidents are often given preference. Primarily, suitable barriers, especially floating barriers, are used, in order to attempt to prevent a further spreading of the oil-carpet or -film. Also, attempts are made to concentrate the oil into thicker layers, in order that it can be collected by suitable take-up equipment.

It is also known to use oil binding agents, which involve substances of hydrophobic and oleophilic character. These are provided as plastic granules, plastic flakes and plastic cubes, for instance of polypropylene- or polyurethane-foam, that are strewn onto the oil to absorb it and which are then removed, after they have been given a time to take effect (DE 1 634 188 A1). Problematic here is not only the mountains of saturated foam plastic bodies, but also the previous bringing them out on the water. In the case of calm inland waters, it is indeed possible to strew these planar bodies from the air over the soiled water surface, but, when it comes to the open sea or to water near the coast, this is not possible, because the wind scatters the very light foam plastic bodies, so that only a small part comes to lie on the soiled water surface.

Object of the present invention, therefore, is to provide a method and equipment, with either of which, as the case may be, the planar bodies of open-cell foam plastic can reach the location of use, i.e. the soiled water surface, with certainty.

To attain this object, the features of claim 1 and claim 18 or 19 are provided in a method and equipment, respectively, of the initially specified type.

By the measures according to the invention, it is achieved that the planar bodies issued under water, when issued in the area of the soiled water surface, also surface there and get applied, since they can neither be carried away by wind and weather, nor can they be washed away by currents, which usually are located significantly deeper. Even after surfacing on the water surface, they offer hold for neither wind nor storm, since they are now heavy because of liquid uptake.

With the features of claim 2, it is achieved that the planar bodies are compressed in the container, so that they can be stored in small volume, which, in turn, leads to increased quantity of contained planar bodies.

Issue of the planar bodies on the waters and from under water into the water surface is accomplished advantageously according to the features of one or more of the claims 3 to 5.

In a preferred embodiment according to the features of the claim 6 or 19, it is achieved that the planar bodies are brought in simple manner to the contamination layers on the water surface and are issued into these areas following the sinking of the container under water. This can be accomplished in various ways from ships, helicopters, airplanes, etc. In this procedure, it is made certain, on the one hand, that the ejected containers sink, and, on the other hand, that they release the planar bodies under water.

Preferred embodiments result from the features of one or more of the claims 7 to 13, respectively 20 to 31.

A sack-shaped container of this type can be filled in calculated manner with weighting, or loading, material and the planar material, such that it is assured that the sack-shaped container will go under following ejection. To get the fastest possible sinking beneath the surface of the water, it is expedient to provide the sack-shaped container with holes or to manufacture it directly from net material.

The opening of this sack-shaped container for issuing the planar bodies can proceed in various ways, for example by the sack-shaped container opening by itself, powered by the water-saturated planar bodies swelling out of the untied opening. Another possibility lies in using a buoy to pull a tear line as the sack-shaped container sinks, in order to free an opening associated with the tear line.

Additionally, the sack-shaped containers should be recoverable as completely as possible following issue of the planar bodies, preferably minus the loading material. This can likewise proceed with the help of a buoy, on whose pull line the sack-shaped container is secured.

An advantageous collecting of the planar bodies saturated with contamination substances, or a separating of the substance from the planar bodies, is achieved with the features of one or more of the claims 14 to 16.

Advantageous sizes for the planar bodies follow from the features of claim 17.

The invention relates also to a container for use in a method of the named type and/or equipment of the named type, wherein the container is characterized by the features of one of the claims 20 to 30.

Further details of the invention will be perceived on the basis of the following description, where the invention is more closely described and explained on the basis of the examples shown in the drawings.

The figures show as follows:

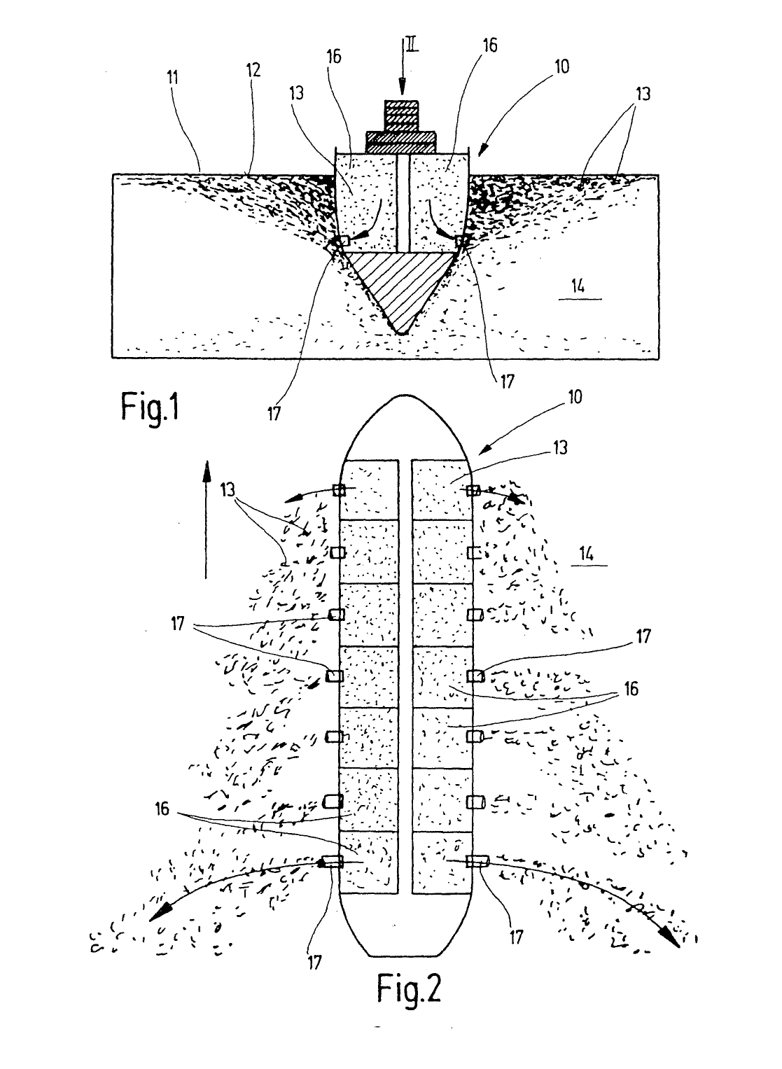

FIG. 1 a schematic cross sectional representation of equipment for removing contamination layers from the water surface according to a first example of the present invention,

FIG. 2 a schematic representation in top view according to the arrow II of FIG. 1,

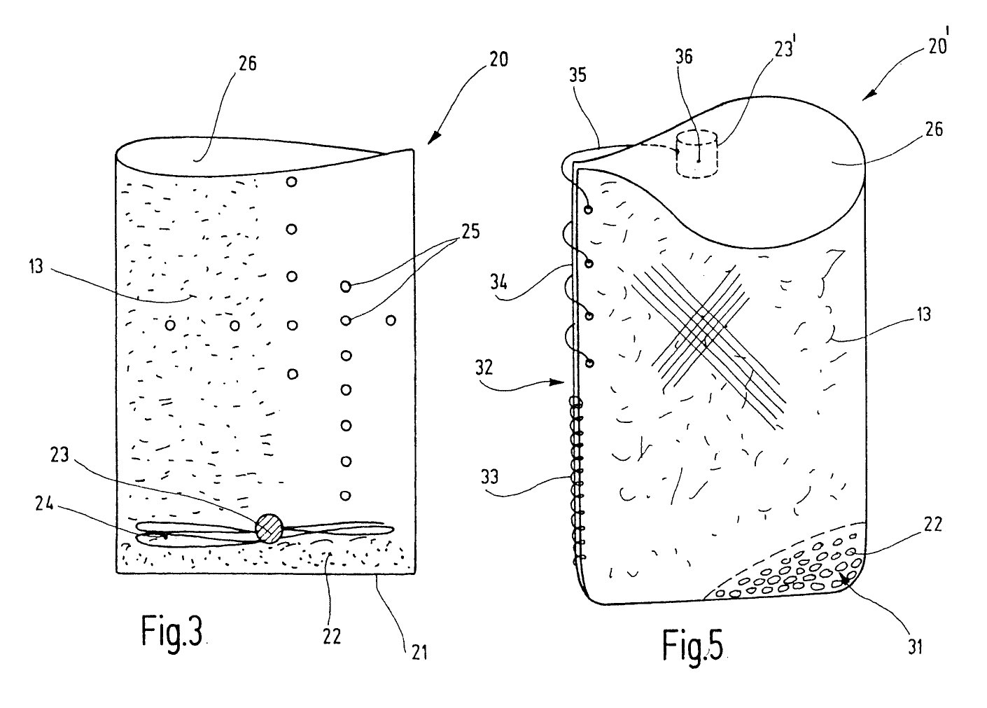

FIG. 3 a schematic side view of equipment in the form of a sack-shaped container according to a second example of the present invention for use in a method or equipment for removing contamination layers from water surfaces,

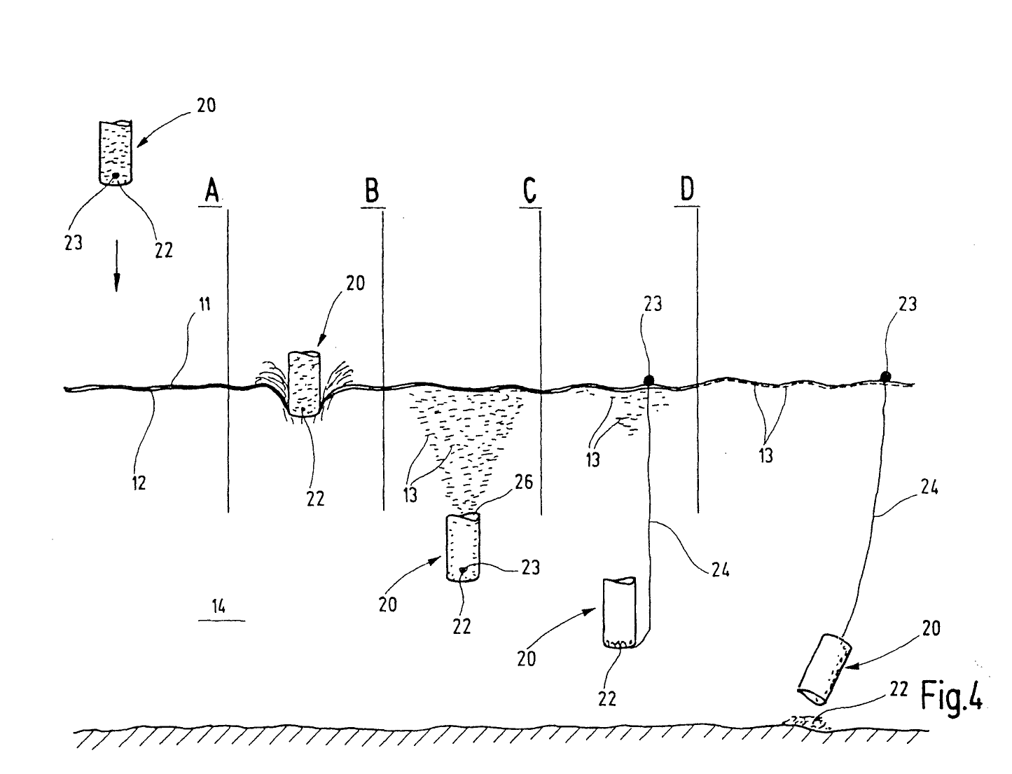

FIG. 4 a schematic representation of a part of the method for removing contamination layers from water surfaces, and

FIG. 5 a schematic side view of a sack-shaped container according to a further example of the present invention.

The method of the invention according to a first embodiment for removing, for example, oily layers 11, such as oil carpets, oil films or the like, from water surfaces 12 of seas and inland waters uses, for example, a ship 10 shown in FIGS. 1 and 2, with which planar bodies 13 of open-cell foam plastic, for example open-pore foamed polyurethane soft foam, are issued under water. The planar bodies 13, which take up liquid, or water, in the waters 14, subsequently move to the water surface 12 and, consequently, to the contamination substance or oily layer 11, since they were issued from the ship 10 into the waters 14 directly under such layer.

The ship 10 of the drawing has, for example, a plurality of chambers 16, in which the planar foam plastic bodies are placed and stored. The planar bodies 13 are filled into each chamber 16 under pressure, which means that the planar bodies 13 of, for example, polyurethane soft foam are squeezed together, so that they can be housed under small volume conditions in optimum numbers in each chamber 16. Each chamber 16 has a discharge opening 17 at the floor of the chamber and located under water, i.e., below the water surface 12, when ship 10 is floating on the waters 14. It is understood that ship 10 can also have only one or two large chambers, instead of a number of smaller separate chambers. In the case of one large chamber for example, the chamber can be provided with several uniformly distributed discharge openings 17 arranged under water.

The issuing of the planar bodies pressed together under pressure can proceed, for example, by means of compressed air or by means of water under pressure taken in from the waters 14. Essential is that the issuing of the planar bodies from the one or more chambers 16 be done in locations underneath the water surface having an oily layer 11. The planar bodies, issued from the one or more chambers 16 and rising in the water, take up water in their open pores and float to the water surface 12 soiled with the oily layer 11, where they give off the water and take up the oily substances, due to their hydrophobic property. In this way, the planar bodies of e.g. open-pore foamed polyurethane soft foam bind the oily substances.

According to an embodiment, which is not shown, the planar bodies 13 of open-cell foam plastic are placed and stored in one or more floating containers pulled, for example, by a tug boat. The placement of the planar bodies 13 into the one or more containers can be done with, or without, pressure. The floating container has, like the chambers 16 of ship 10, an underwater discharge opening through which the planar bodies 13 are issued. In order to assure that the discharge opening is always under water, the container has, on the basis of its own weight or on the basis of weights hung on it, an appropriate draft.

It is understood that the above-mentioned containers filled with planar bodies 13 can also be in the form of tubes towed by a ship. The planar bodies can be blown or washed out of the outlet end of the tube under the water surface in the area of the oily layer.

According to a further embodiment, which is not shown in the drawings, the planar bodies 13 are housed in a restrictively-meshed net that is pulled through the waters 14 to the area of the water surface 12 soiled with the contamination substance or oily layer 11. Upon reaching this area, the net can be opened, so that the planar bodies stored uncompressed therein can escape into the waters 14.

The planar bodies 13 have the shape of plates, or platelets, of relatively small size, with a thickness in the range of about 1-2 cm, and a base surface (width×length) in the range from about 3×5 cm to 6×10 cm. This size of plates avoids, in contrast to the situation with plates of larger surface, that the plates overlap, or lie on one another, when in use on the water surface 12, or on the contamination layer 11, which would decrease the efficiency of the absorbing, or binding, of the contamination layer 11 by the open-pore planar bodies 13. For this reason and for manufacturing technical reasons, the bodies 13 which are used are planar and not absolutely spherical or the like.

Following underwater issue of the planar bodies 13, their surfacing on the water surface 12 in the area of the oily layer, or layers, and after “saturation” of the planar bodies 13 with the oily substance, the planar bodies 13 containing the oily substance are then brought back in. This occurs, for example, by the planar bodies 13 carrying or binding the oily substance being fished-in, or collected, with nets, for example in the form of purse seines, and brought to the area of the ship. The planar bodies 13 carrying the oily substance are then vacuumed from the water surface using ship-based suction equipment ship and fed to a separating device on the ship. The vacuuming occurs preferably at a certain distance above the water surface, in order to entrain as little water as possible. On the ship, the planar bodies soaked with the oily substance are wrung out, to free them, for the most part, of the oil. The wringing out can be done, for example, with the help of a centrifuge or a calender.

It is understood that the collecting, or the concentrating of the fished-in planar bodies soaked with the oily substance, can also proceed, instead of on a ship, on the shore, or coast, where appropriate suction equipment and, if necessary, a wringing plant can be provided. The wrung planar bodies 13 can be used again, since they are essentially free of the oily substance.

The described process serves to remove contamination layers 11 from the water surfaces 12. Such contamination layers can be oily layers, for example oil carpets, oil films, or liquid plastic layers, for instance styrene films or the like. Water surfaces 12 are those of seas or inland waters. The binding of these contamination layers is done using planar bodies 13 of open-cell foam plastic, e.g. open-pore foamed polyurethane soft foam. It is understood that other soft foams can be used, for example those of polyethylene (PE) or polypropylene (PP). Essential is that the planar bodies 13 be issued beneath the surface 12 of the waters 14 in the area of the contamination layer or layers 11 and that they rise from beneath the water surface 12 to the contamination layer 11.

According to the second embodiment, FIG. 3 shows a sack-shaped container 20 that is filled with planar bodies 13. On the floor 21 of sack 20, a weighting, or loading, material 22 is provided, or charged, such as e.g. sand, gravel or the like. Between the loading material 22 and the planar bodies 13, a buoy 23 is provided, which is connected to one end of a pull line 24, whose other end is secured on the outside, preferably in the area of the floor. The planar bodies 13 are preferably compressed into the sack 20, so that the planar bodies 13 always consume a smallest possible compressed volume in the sack 20.

The weight ratio of the planar bodies 13 and the loading material 22 is such that the weight of the loading material 22 is greater than the combined buoyancy force of the planar bodies 13 and the buoy 23 present in the sack. In other words, it must be made certain that the thus-filled sack 20 later will sink relatively quickly under water. Sack 20 also has a plurality of holes 25 in the sack material, in order that, upon plunging into the waters 14 and diving under the water surface 12, water penetrates into the sack through the holes 25 and the planar bodies 13 can fill themselves, so that they swell. In an embodiment which is not shown, the sack 20 is made of net material, in order to achieve this. The mesh size of the net material is smaller than the selected smallest side-edge length of the planar bodies 13, or smaller than the external dimension of a planar body compressed in sack 20.

The sack of FIG. 3 has an unclosed opening 26 on the upper side, from which in the starting condition, when the planar bodies are compressed in sack 20, essentially no planar bodies 13 can escape. It is, however, also possible to equip the sack 20 in the area of its upper opening 26 with laterally superimposable flaps, in order to prevent escape of the planar bodies 13 from the sack 20 in the starting condition, while still assuring that the flaps open, or spread apart, under the pressure of the planar bodies filling with water, in order to free opening 26 for escape of the planar bodies.

FIG. 4 shows in separate method steps a part of the method for removing contamination layer 11 from water surface 12. The first method steps shown here serve the purpose of bringing the planar bodies 13 in simple and sure manner to the contamination layer 11, in order that this layer can be absorbed or bound by the planar bodies 13. In further method steps (not shown), the planar bodies 13 filled with the contamination substance of layer 11 are collected and brought to press out and/or clean up.

Proceeding from the left, the first figure segment 4A illustrates the sacks 20 in the filled state of FIG. 3 being ejected above a water surface 12 covered with a contamination layer 11. The ejection can be done from a ship, a helicopter, an airplane, or the like. The sacks 20 assume over the course of the fall an ejection orientation shown in this figure segment 4A, where the region of the sack 20 filled with the loading material 22 points downwards and is moving in the lead position.

The second figure segment 4B shows the impact of a sack 20 on the water surface 12 and its initial plunge into the waters 14.

The middle figure segment 4C shows the sinking of the immersed sack 20 beneath the water surface 12 in the area of the contamination layer 22. During this, the planar bodies saturate with water, expand, and spread out of the opening 26, perhaps with the movement of cover flaps out of the opening 26, and float upwards to the water surface 12 and the contamination layer 11. There the planar bodies 13 saturate with the substances of the contamination layer 11. Following the planar bodies 13, buoy 23 can come out of the sack and likewise move upwards, as illustrated in the fourth figure segment 4D. The pull line 24 is of suitable length, such that the buoy holds the sack 20 before it reaches the bottom of the waters 14 and, in the process, turns the sack 20 upside down, so that the loading material 22 can discharge and sink to the bottom of the waters 14. By means of the buoys 23, the sacks 20 can then be collected.

In this case too, the planar bodies 13 saturated with the contamination layer 11 are brought in. The planar bodies carrying, or binding, the contamination substance are fished-in, or collected, by means of nets in the form of e.g. purse seines and transported e.g. to a ship. Here, it is possible to implement the collecting using a definite enclosing of the contamination layer 11. The contamination layer 11 or the planar bodies 13 floating there are surrounded with nets and the thus arranged fencing nets are transported to a collecting location. In this connection, it is conceivable that the planar bodies held by these fencing nets are brought to this collecting location by wind and/or waves. From the collecting location, the planar bodies 13 are brought to a separating device, for instance on a ship, where the contamination substance is removed from the planar bodies by e.g. squeezing, centrifuging, and/or the like.

FIG. 5 shows a further embodiment of a sack, a sack 20′ also filled with loading material 22 and planar bodies 13. This embodiment has a chamber 31 in one corner of the floor area, where the loading material 22 is arranged. The asymmetric placement of the loading material 22 in the sack 20′ serves for the purposeful and rapid plunging or diving of the ejected sack 20′. Sack 20′ is closed on a peripheral side 32. In this connection, a lower region 33 is provided in which the side 32 is tightly sewed or closed. Then in an upper region 34 adjoining lower region 33, a tear line 35 is sewn into the side 32. The free end of the tear line is connected to a buoy 23′. The buoy 23′ is held by way of a breakable connection on an outer peripheral side of sack 20′. The upper opening 26′ can be open or closed.

Upon the throwing or ejection of the sack 20′ and its meeting of the water surface 12 in the area of the contamination layer 11, buoy 23′ becomes separated from the sack 20′ because of the impact force and the buoyancy force exerted on the buoy 23′, so that the buoy 23′ remains on the water surface, or else at least reaches it in a short time. When the length of the tear line 35 become taut, the upper region 34 of side 32 of the sack 20′ gets opened by the pull on the tear line 35, so that the planar bodies 13 emerge quickly from the sack 20′ and, as shown in FIG. 4, can move to the contamination layer 11 on the water surface.

According to a further embodiment (not shown) of the present invention, a chamber filled with loading material is arranged on the outside of the floor region of the sack 20 or 20′ and connected with the sack by a tear line. This tear line is also connected with a buoy. Following the diving of the sack, a pull is exerted between the buoy and the loading material chamber over the tear line, and this releases the loading material chamber from the sack. In this way, it is no longer necessary to dump the loading material out of the sack.

According to another embodiment, the container can be made partially or completely of a material which dissolves in water.

1. Method for removing contamination layers, such as oily layers, e.g. oil carpets, oil films, or such as liquid plastics, e.g. styrene films or the like, from water surfaces by using planar bodies of open-cell foam plastic, e.g. open-pore foamed PP- or PU- or PE-soft foam, wherein the planar bodies are issued onto the water surface and following their saturation with the contamination substances are collected, characterized in that the planar bodies are issued under water.

2. Method as claimed in claim 1, characterized in that the planar bodies are stored in a container under pressure and issued from there into the water.

3. Method as claimed in claim 1 or 2, characterized in that the planar bodies are housed in the hull of ships and issued from there.

4. Method as claimed in claim 1 or 2, characterized in that the planar bodies are housed in containers, nets or the like towed under water by ships and issued from there.

5. Method as claimed in at least one of the preceding claims, characterized in that the planar bodies are washed out of the container or the like.

6. Method as claimed in claim 1, characterized in that the planar bodies are placed in openable or open containers for their issuance under water, which containers are provided with sufficient loading material to submerge under water, and that the thus-filled containers are ejected over the one or more contamination layers.

7. Method as claimed in claim 6, characterized in that a sack automatically openable under water is used as the container.

8. Method as claimed in claim 7, characterized in that the sack is provided with holes or made of a restrictively-meshed net.

9. Method as claimed in claim 7 or 8, characterized in that the sack contains loading material in the form of pebbles, sand, or the like.

10. Method as claimed in at least one of the claims 7 to 9, characterized in that the planar bodies are pressed into the sack over the loading material.

11. Method as claimed in at least one of the claims 7 to 10, characterized in that the sack is provided at the upper end with closure flaps, which are laid loose over one another to close the upper exit of the sack.

12. Method as claimed in at least one of the claims 7 to 10, characterized in that an upper or lateral exit of the sack is closed with a tear line, whose free end is connected to a buoy.

13. Method as claimed in claim 6 and claims 9 and/or 10, characterized in that the container is made of a material which is completely or partially soluble in water.

14. Method as claimed in at least one of the preceding claims, characterized in that the planar bodies saturated with contamination substances are encircled by means of nets of the purse seine type and collected and subsequently vacuumed from the water surface.

15. Method as claimed in claim 14, characterized in that the planar bodies are placed on a ship.

16. Method as claimed in claim 14 or 15, characterized in that the planar bodies are wrung out e.g. by means of a centrifuge or calender.

17. Method as claimed in at least one of the preceding claims, characterized in that the planar bodies are used in the form of small plates having a base surface size range between about 3×5 cm and 6×10 cm and a thickness of about 1-2 cm.

18. Equipment for practice of the method as claimed in at least one of the claims 1 to 5, characterized by a floating or underwater-going receiving chamber (16), in which the planar bodies (13) are housed preferably under pressure and which is provided with an underwater discharge opening (17) for the planar bodies.

19. Equipment for removing contamination layers (11), such as oily layers, e.g. oil carpets, oil films, or such as liquid plastic layers, e.g. styrene films or the like, from water surfaces (12) by using preferably planar bodies (13) of open-cell foam plastic, e.g. open-pore foamed PP- or PU- or PE-soft foam, having a device for issuing the planar bodies (13) and a device for collecting the planar bodies (13) saturated with the contamination substances, characterized in that the device for issuing the planar bodies (13) is formed by a container (20) that is openable or open under water and that is filled with sufficient loading material (22) for submerging, or holding, under water.

20. Equipment as claimed in claim 19, characterized in that the container is a sack (20) automatically openable under water.

21. Equipment as claimed in claim 20, characterized in that the sack (20) is provided with holes (25) or made of a restrictively-meshed net material.

22. Equipment as claimed in claim 20 or 21, characterized in that the sack (20) contains loading material (22) in the form of pebbles, sand, or the like.

23. Equipment as claimed in at least one of the claims 20 to 22, characterized in that the planar bodies are pressed into the sack (20) above the loading material (22).

24. Equipment as claimed in claim 23, characterized in that the sack (20) is provided at its floor end with a chamber (31) for the loading material (22).

25. Equipment as claimed in at least one of the claims 22 to 24, characterized in that the sack (20) is provided at the upper end with closure flaps, which are laid loose over one another to close the upper exit of the sack.

26. Equipment as claimed in at least one of the claims 20 to 23, characterized in that an upper or lateral exit (34) of the sack (20) is closed with a tear line (35), whose free end is connected to a buoy (23).

27. Equipment as claimed in at least one of the claims 19 to 26, characterized in that a chamber for the loading material (22) on the floor-end region of the sack (20) is connected with a tear line, whose free end is connected to a buoy.

28. Equipment as claimed in claim 26 or 27, characterized in that the buoy (23) is held on the sack (20) such that it can tear free upon meeting the water surface (12).

29. Equipment as claimed in at least one of the claims 19 to 28, characterized in that, at the floor-end region of the sack (20), a pull line (24) is attached, whose other end is connected with a buoy (23).

30. Equipment as claimed in claim 9 and one of the claims 22 and/or 23, characterized in that the container (20) is made of a material which is completely or partially soluble in water.

31. Equipment as claimed in at least one of the claims 19 to 30, characterized in that a device for ejecting the filled container (20) over the one or more contamination layers (11) is provided.

32. Container (20) for use in a method as claimed in claim 6 and/or in an equipment as claimed in claim 19, characterized by the features as claimed in at least one of the claims 20 to 30.
